(19) United States
(12) Patent Application Publication
(10) Pub. No.: US 2014/0203165 A1
(43) Pub. Date: Jul. 24, 2014

(54) Coupling Device For a Trough-Like Female Form and Device For Producing Bottom Parts of a Shaft

(71) Applicant: Klaus Muller, Blaubeuren-Gerhausen (DE)

(72) Inventor: Klaus Muller, Blaubeuren-Gerhausen (DE)

(73) Assignee: BFS Betonfertigteilesysteme GmbH, Blaubeuren (DE)

(21) Appl. No.: 14/009,244

(22) PCT Filed: Mar. 30, 2012
(86) PCT No.: PCT/EP12/55851

§ 371 Date: Apr. 1, 2014

(30) Foreign Application Priority Data
Apr. 1, 2011 (DE) 20 2011 004 703.2

(51) Int. Cl. B28B 7/16; F16B 25/00

(52) U.S. Cl. CPC B28B 7/16; F16B 25/0005
USPC 249/188; 411/396

(57) ABSTRACT

The present invention provides a coupling body (32) for coupling a negative channel mould (24), which produces a channel portion of a shaft bottom part (12) to be manufactured from concrete, with a holding device (22), the coupling body (32) comprising a fixing portion (34) for fixing the coupling body (32) to the negative channel mould (24) and first coupling means (42) for magnetically coupling with a first counter coupling means (52) of the holding device (22), wherein the coupling body (32) further comprises second coupling means (48) for mechanically coupling with second counter coupling means (54) of the holding device or of another device.

The present invention relates to a coupling body for coupling a negative channel mould, which produces a channel portion of a shaft bottom part to be manufactured from concrete, with a holding device. The invention further relates to a device for producing shaft bottom parts from concrete, comprising a negative channel mould, a coupling body of the above-mentioned type and a holding device with which the negative channel mould is to be coupled.

Shaft bottom parts form the lower end of a multiple-piece underground shaft, via which a sewer system is accessible for inspection and maintenance. In this bottom region of the shaft, said shaft comprises at least one inlet opening and one outlet opening on the side wall thereof for admitting and discharging waste water respectively. In addition, a channel structure is formed in the shaft bottom part, which structure interconnects the inlet and outlet openings. Depending on the number and arrangement of the inlet and outlet openings, the channel structure can have various designs, can be branched, can have a certain gradient or can provide various flow cross-sections.

A shaft bottom part to be manufactured from concrete for a shaft of the above-mentioned type comprises a shaft wall, which continues the shaft wall of a shaft part to be arranged thereabove, and a bottom portion in which the channel structure is formed. In order for it to be possible to manufacture shaft bottom parts with different channel arrangements and different arrangements of inlet and outlet openings in a technically relatively simple manner, methods are known from the prior art in which the mould for moulding the shaft bottom parts is composed of a basic mould and a negative channel mould, the basic mould forming the portions of the shaft bottom part which are not to be altered, more particularly the shaft walls, while the negative channel mould forms the channel structure in the bottom region of the shaft bottom parts. Various channel structures can thus be produced by simply substituting the negative channel mould.

A device for producing a shaft bottom part is known from DE 20 2009 017 953 U1, in which a base body produced from a mixture of sand and a binding agent is processed using a milling process, in order to produce the negative geometry of a channel structure to be formed, the negative channel mould then being coupled with a mould core of a basic mould to form a shaft bottom part. In order to ensure that the negative channel mould is held securely on the mould core, more particularly to prevent the negative channel mould from slipping or floating when the mould is filled with concrete, a threaded sleeve is inserted into the negative channel mould, into which sleeve a screw can be screwed from the mould core once the negative channel mould has been placed onto the mould core, such that a mechanical connection is produced between the mould core and the negative channel mould. Once the shaft bottom part has been cast, the screwed connection is released and the negative channel mould is destroyed, in order to remove the finished shaft bottom part from the mould.

A drawback of a mechanical coupling of this type between a negative channel mould and a mould core is that the assembly of the negative channel mould is highly complex, since the mechanical coupling means are positioned on the contact face between the negative channel mould and the mould core and thus can only be accessed with difficulty. In addition, more work is required to release the mechanical coupling.

The coupling between a negative channel mould and a mould is simplified by a magnetic coupling, as proposed for example in EP 1 627 716 B1. In this device, the negative channel mould comprises cavities, which are closed by the surface of the mould core. In one of said cavities, a permanent magnet is screwed to an inner wall of the negative channel mould by means of a corner bracket. Using said permanent magnet, the negative channel mould can be stuck to a surface, made of ferromagnetic metal, of the mould core in a relatively simple manner.

By using a magnetic coupling as proposed in EP 1 627 716 81, the attachment and release of the negative channel mould to/from the mould core is indeed simplified; however the complexity of producing the negative channel mould increases simultaneously, since the assembly of the permanent magnet with the corner bracket in a cavity of the negative channel mould is relatively complicated. In addition, EP 1 627 716 B1 does propose a foamed plastics material as a material for producing the negative channel mould, such that the processing of the geometry of the negative channel mould is simplified and the costs of the negative channel mould can be reduced; however the use of said material in the known device is disadvantageous in that said material is not strong enough to stably fix the permanent magnets to the relatively thin walls of the cavity, in that it is difficult to separate the negative channel mould from the finished shaft bottom part and in that, owing the low strength of the foamed plastics material, the negative channel mould could be destroyed.

Proceeding from the above-mentioned drawbacks of the known devices and methods, the problem addressed by the present invention is that of providing a coupling body which makes it possible for a negative channel mould to be simply and reliably coupled with and decoupled from a holding device and which, in addition, can promote the removal of the negative channel mould from the shaft bottom part. Another problem addressed by the invention is that of providing a device and a method for effectively producing shaft bottom parts from concrete which are simple to operate/construct, can be flexibly adjusted to various channel structures and make it possible to re-use negative channel moulds.

According to a first aspect of the present invention, the problem is solved by a coupling body for coupling a negative channel mould, which produces a channel portion of a shaft bottom part to be manufactured from concrete, with a holding device, the coupling body comprising a fixing portion for fixing the coupling body to the negative channel mould and first coupling means for magnetically coupling with a first counter coupling means of the holding device, wherein the coupling body further comprises second coupling means for mechanically coupling with second counter coupling means of the holding device or of another device.

The coupling body according to the invention thus comprises first coupling means for magnetic coupling and also second coupling means for mechanical coupling. The same coupling body can thus both be simply and rapidly coupled with a holding device by magnetic force, and can also be mechanically coupled with the holding device or with another device by means of the second coupling means, in order to provide a secure coupling for also transmitting high forces.

A negative channel mould, to which the coupling body according to the invention is fixed, can more particularly be stuck rapidly and simply to a mould core (holding device) of a mould for producing shaft bottom parts from concrete, by the first coupling means resting magnetically on counter coupling means of the basic mould. Once the shaft bottom part is moulded, the mechanical coupling of the second coupling means can then be produced in order to also transmit high tensile force to the negative channel mould for removing the negative channel mould. The removed negative channel mould can then be re-used.

The first coupling means for magnetic coupling can comprise a permanent magnet. Permanent magnets are relatively cost-effective and provide virtually maintenance-free, permanent operation. The first coupling means for magnetic coupling can, however, alternatively comprise a portion made of magnetisable (more particularly ferromagnetic) material, such that the coupling body can interact with a magnet of the holding device.

The first and second counter coupling means can both be provided on the holding device. Advantageously, the second counter coupling means are however arranged on another device, for example on a pulling device, using which the negative channel mould is pulled from (removed from) the concrete of the shaft bottom part once the shaft bottom part has been moulded and said shaft bottom part has set at least in part.

In a preferred embodiment, the second coupling means are designed for the attachment of a hook coupling element. A hook coupling element provides a mechanical coupling which is simple yet well designed for transmitting high tensile forces, such that the negative channel mould can simply and reliably removed in this way. The hook coupling element is to be understood as a part of a hook coupling, that is to say can be formed by a hook or an eye.

The second coupling means preferably comprise an indentation, that is to say the mechanical engagement between the second coupling means and the second counter coupling means takes place in an indentation. In this way, the mechanical coupling means substantially do not project beyond the bottom surface of the negative channel mould, such that the negative channel mould can rest on the holding device with a substantially continuous contact face. The magnetic coupling between the first coupling means and the first counter coupling means is simplified thereby.

In principle, the coupling body can be fixed to the negative channel mould by means of suitable assembly means which are known per se. Simplified and simultaneously reliable fixing is, however, achieved in an embodiment of the invention, in which the fixing means comprises a thread which is arranged in a rotationally fixed manner on the coupling body, the thread axis of which thread extends coaxially with a main axis of the coupling body. In an embodiment of this type, the coupling body is helical in its entirety and can be screwed into the negative channel mould by simple rotation about the main axis. The first and second coupling means can then advantageously be housed in a head portion of said helical coupling body.

In a further embodiment of the invention, the fixing portion comprises a rod which is wound into a helix and is fixedly arranged on the coupling body. By rotating the coupling body about a main axis, the helically or spirally wound rod can then penetrate the material of the negative channel mould and can reliably fix the coupling body in a simple assembly process.

In addition, the rod which is wound into a helix makes it possible for the coupling body to also be fixed in softer materials, more particularly in a foamed plastics material, and can for example render unnecessary the provision of threaded sleeves which are to be inserted into the negative channel mould, such that the assembly complexity of fixing the coupling body can be further reduced.

If the fixing portion of the coupling body is equipped with a thread which is coaxial with the main axis of the coupling body or with the above-mentioned rod which is wound helically about the main axis, the coupling body can further advantageously comprise a tool engagement portion, which is designed to engage in a twist-proof manner with a rotary tool in order to rotate the coupling body about the main axis. A rotary tool, such as a screwdriver provided with a corresponding attachment, can then be placed onto the tool engagement portion and the coupling body can be reliably fixed to the negative channel mould in a simple, single process of rotation.

In this case, the tool engagement portion can likewise be designed such that it does not project beyond the bottom surface of the negative channel mould, and specifically by it comprising a recess, preferably a plurality of recesses distributed around the main axis. More particularly, the entire coupling body can then be countersunk in the negative channel mould in the manner of a countersunk screw, such that substantially none of the coupling body projects beyond the bottom surface and the negative channel mould is thus prepared to fully contact a corresponding surface of the holding device.

According to a second aspect of the invention, the above-mentioned problem addressed by the invention is solved by a device for producing shaft bottom parts from concrete, comprising a negative channel mould, which produces a channel portion of a shaft bottom part, a coupling body according to the first aspect of the invention, a holding device, with which the negative channel mould is to be coupled in order to hold the negative channel mould while the shaft bottom part is moulded, the holding device comprising the first counter coupling portion, and a pulling device for pulling the negative channel mould out of a moulded shaft bottom part which is set at least in part, the pulling device comprising the second counter coupling means for mechanically coupling with the second coupling means of the coupling body.

Using the device of the second aspect of the invention, shaft bottom parts having various channel structures can be flexibly manufactured, since the negative channel mould can be easily substituted and can be coupled with the holding device by means of the magnetic first coupling means in a simple manner, by the negative channel mould being simply placed onto the mould core. At the same time, the mechanical coupling means make possible a high level of force transmission between the pulling device and the negative channel mould, such that the shaft bottom part can be reliably separated from the negative channel mould. In addition, the advantages and effects described above in conjunction with the embodiments of the coupling body of the first aspect of the invention also apply to a device, using a coupling body of this type, of the second aspect of the invention.

The negative channel mould is preferably formed from a foamed plastics material, more particularly from Styropor, such that the negative channel mould is light and is easy to handle as a result, more particularly can be carried by just one person. In addition, a negative channel mould made of foamed plastics material can be produced in a cost-effective manner and can be machined to a desired geometry.

Further embodiments of the device of the second aspect of the invention are set out the dependent claims.

According to a third aspect of the present invention, the above-mentioned problem is solved by a method for producing a shaft bottom part made of concrete, comprising the steps of fixing a coupling body to a negative channel mould, which produces a channel portion of a shaft bottom part to be manufactured from concrete, attaching the negative channel mould to a holding device by magnetically coupling first coupling means of the coupling body with first counter coupling means of the holding device, moulding a shaft bottom part from concrete to the negative channel mould, mechanically coupling second coupling means of the coupling body with second counter coupling means of a pulling device, and pulling the negative channel mould from the shaft bottom part using the pulling device.

By means of the method of the third aspect, the advantages and effects described above in conjunction with the coupling body of the first aspect and the device of the second aspect can accordingly be achieved. More particularly, the coupling body used in the method of the third aspect can be an above-described coupling body of the first aspect of the invention.

The invention is described in greater detail in the following on the basis of preferred embodiments with reference to the accompanying drawings, in which:

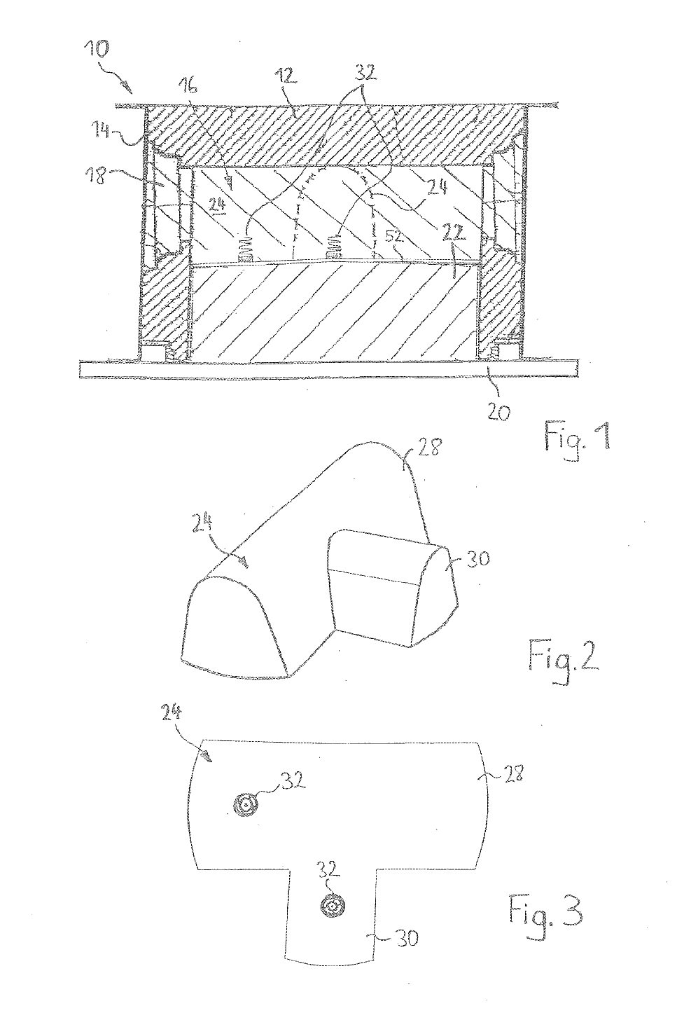

FIG. 1 is a cross-section of a device for producing shaft bottom parts from concrete according to an embodiment of the present invention,

FIG. 2 is a perspective view of a negative channel mould of the device shown in FIG. 1,

FIG. 3 is a bottom view of the negative channel mould shown in FIG. 2,

FIG. 4 is a perspective view of a coupling body for the negative channel mould shown in FIGS. 2 and 3,

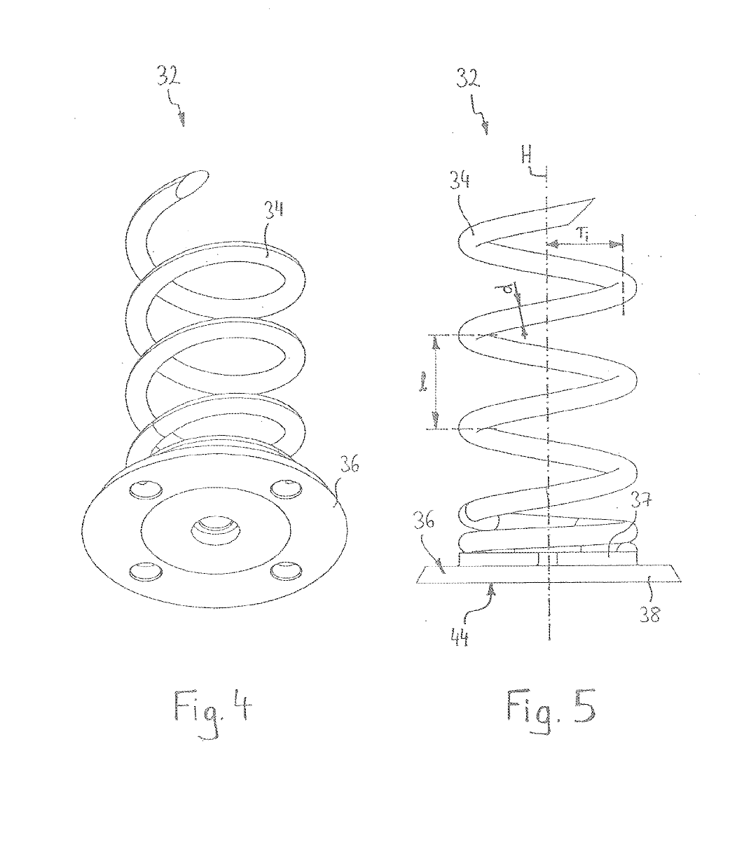

FIG. 5 is a side view of the coupling body shown in FIG. 4,

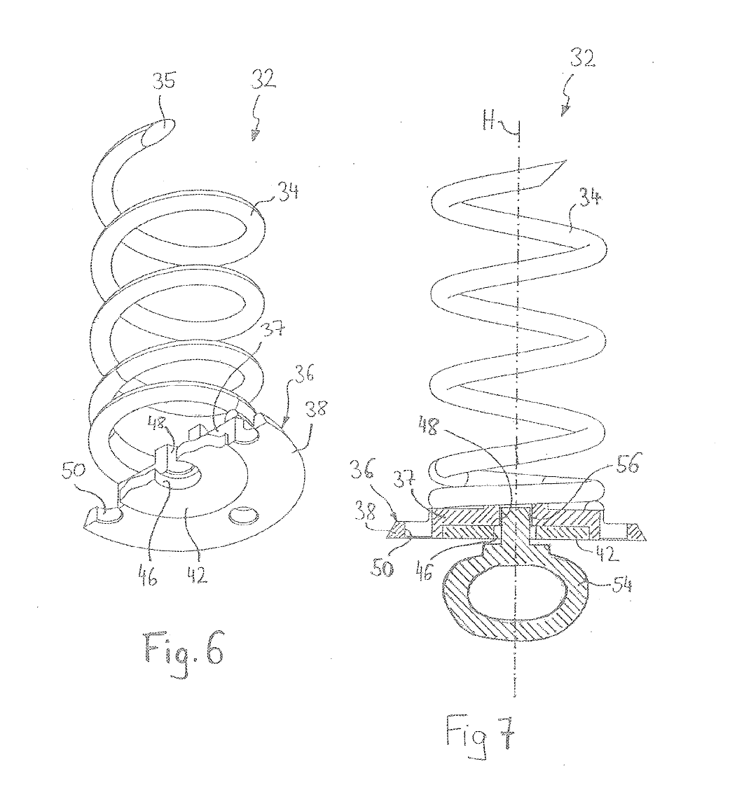

FIG. 6 is a perspective view of the coupling body shown in FIG. 4, with a head portion which is cut away,

FIG. 7 is a side view of the coupling body shown in FIG. 4, with a head portion which is cut away and a hook element mounted thereon.

With reference to FIG. 1 to 7, embodiments for a device and a method for producing shaft bottom parts from concrete, and for a coupling body used therein, are explained in the following. A device 10 shown in FIG. 1 for producing shaft bottom parts 12 from concrete in a casting process comprises a mantle 14 for moulding an outer wall of the shaft bottom part 12, an inner negative mould 16 for moulding the inner wall and the channel portion of the shaft bottom part 12, and recess cores 18 for moulding the inlets and outlets of the shaft bottom part 12. A shaft bottom part 12 is formed in the cavity which is formed between the mantle 14 and the inner negative mould 16 and the recess cores 18 respectively.

The mantle 14 can comprise a cylindrical wall and can be positioned on a base plate 20, on which the inner negative mould 16 is also positioned. The inner negative mould 16 can be composed of a mould core 22 positioned on the base plate 20 and a negative channel mould 24 placed on the mould core 22, it being possible for the mould core 22 to mould an inner wall, more particularly a cylindrical inner wall, of the shaft bottom part 12 and it being possible for the negative channel mould 24 to mould a channel portion on the bottom of the shaft bottom part 12 for connecting the inlets and outlets.

When producing shaft bottom parts, it is often required that different types of shaft bottom parts be produced, which have substantially the same external dimensions and the same shaft diameters, but have different channel structures which differ from one another in the number of inlets and outlets and in the design of the connections between the inlets and outlets (more particularly inclination, flow cross-section). Therefore, the approach is preferably followed of producing the mantle 14 and the mould core 22 of the inner negative mould 16 from very robust components which are designed for continuous operation, for example from steel, and of manufacturing the recess cores 18 and the negative channel mould 24 from materials which are easy to machine and/or are relatively cost-effective, since these parts need to be individually provided for a desired channel structure and thus need to be held available in large numbers. Styropor, for example, is a possibility for a material for the negative channel mould 24 and the recess cores 18, as is used in the following to represent a range of other cost-effective materials which are easy to process.

The negative channel mould 24 shown in FIGS. 2 and 3 can be produced from a, for example cylindrical-block-shaped, Styropor blank (not shown) using shaping material processing. More particularly, the desired geometry or surface contour of the negative channel mould 24 can be milled from the blank in order to produce a desired channel structure by means of an automated milling tool, for example using a robot which is controlled by an electronic control unit in accordance with a virtual three-dimensional model of the channel structure. In the embodiment in FIGS. 2 and 3, the negative channel mould 24 comprises a main channel portion 28 for forming a main channel branch of the subsequent channel structure of the shaft bottom part and a secondary channel portion 30 which is integral with the main channel portion 28 for forming a secondary channel branch of the channel structure.

Before the actual moulding of the shaft bottom part 12 in the device 10, the negative channel mould 24 is placed onto the mould core 22 of the device 10. In order that the negative channel mould 24 remains in its desired position while being filled with concrete and neither slips nor floats in the concrete, the negative channel mould 24 is coupled with the mould core 22 by at least one coupling body 32, which is explained in greater detail below with reference to FIG. 4 to 6. The coupling body 32 comprises a fixing portion 34 for fixing the coupling body to the underside of the negative channel mould 24 and a head portion 36 for coupling to the mould core 22. In the embodiment, the fixing portion 34 is formed by a rod wound into a helix, which rod is wound about a central main axis H, such that the rod of the fixing portion 34 has substantially the same spacing from the main axis H at each point. The fixing portion 34 is rigidly connected to the head portion 36 at one end, such that rotating the head portion about the main axis H causes a helical rotation of the fixing portion 34 about the main axis H. The other end 35 of the rod is pointed.

The helically wound rod of the fixing portion 34 can further be understood as a spiral, in the embodiment, the pitch I between two adjacent windings of the spiral being greater than a thickness d of the wound rod. In addition, an inner radius rᵢ of the helical winding, that is to say a radial distance between the wound rod and the main axis H, is preferably greater, more particularly several times greater, than the thickness d of the rod. In the embodiment, the entire fixing portion 34 comprises approximately 4-5 windings of the rod.

The head portion 36 is generally plate-shaped and comprises an indented portion 37 (bottom of the plate) and a flange-like, wide side portion 38 (side of the plate), which the main axis H and the indented portion 37 concentrically surround. A permanent magnet 42 is inserted into the indented portion 37, such that a surface of the permanent magnet 42 is flush with the side portion 38. On the side opposite the fixing portion 34, the head portion 36 thus comprises a substantially planar contact face 44, by means of which the coupling body can rest fully on a counter contact face of the mould core 22.

In a central portion about the main axis H, the permanent magnet 42 comprises a through-opening 46, which exposes a threaded hole 48 therebehind in the indented portion 37, which hole comprises an internal thread. The threaded hole 48 extends coaxially with the main axis H.

In addition, a plurality of tool engagement portions 50 are arranged in the side portion 38 of the head portion 36, onto which engagement portions a tool for rotating the coupling body 32 about the main axis H can be placed. In the embodiment, the tool engagement portions 50 are formed by circular indentations (for example four indentations), which are distributed around the main axis H evenly on the side portion 38.

In the following, a method for producing a shaft bottom part according to an embodiment of the invention is described, which demonstrates both the operation of the above-described device 10 and the above-described coupling body 32 of the embodiment.

At least one coupling body 32 of the above-described type is firstly fixed to an underside of the negative channel mould 24. For this purpose, the coupling body 32 is held manually or by means of a tool and is placed on the negative channel mould 24, such that the pointed front end 35 of the wound rod of the fixing portion 34 firstly penetrates the material of the negative channel mould 24. By rotating the coupling body 32 about the main axis H and simultaneously pressing towards the negative channel mould 24, the coupling body 32 is then screwed into the negative channel mould 24. In this case, the screwing in can be started manually or by means of a transition tool until the coupling body 32 supports itself on the negative channel mould 24, and the screwing in can then be continued by means of a rotary tool.

In the embodiment, the tool used to screw in the coupling body 32 comprises a plurality of projections, more particularly two or four projections, which are designed to be inserted into the recesses in the tool engagement portions 50, such that they entrain the coupling body 32 when the tool rotates. The tool can more particularly be a hydraulically or electrically driven rotary tool, for example a screwdriver attachment.

If the coupling body 32 is screwed completely into the negative channel mould 24, the head portion 36 also lowers into the material of the negative channel mould 24 such that the substantially planar contact face 44 of the head portion 36 is flush with the lower surface of the negative channel mould 24 or the head portion 36 is countersunk somewhat further into the underside of the negative channel mould 24. If the negative channel mould 24 is then placed onto an upper contact face 52 of the mould core 22, the full contact between the negative channel mould 24 and the mould core 22 is not prevented by the coupling body 32.

The upper contact face 52 of the mould body 22 comprises at least one counter coupling element, which can magnetically interact with the permanent magnet 42 of the coupling body 32 in order to hold the coupling body 32 on the mould core 22. In the embodiment, the upper contact face 52 is made of a ferromagnetic material, for example from a steel plate, such that the permanent magnet adheres thereto.

In principle, the use of a single coupling body 32 for coupling between the negative channel mould 24 and the mould body 22 is sufficient. However, a plurality of coupling bodies 32 are preferably provided for reliable coupling. In the embodiment shown, a first coupling body 32 is fixed in the main channel portion 28 of the negative channel mould 24 and a second coupling body 32 is fixed in the secondary channel portion 30 of the negative channel mould 24.

Once the negative channel mould 24 has been placed onto the mould core 22, the recess cores 18 can be placed onto the respective longitudinal ends of the main channel portion 28 and the secondary channel portion 30 and can be fixed in the device 10, and the mantle 18 is closed. Subsequently, the device 10 can be filled with concrete in order to form the shaft bottom part 12. Once the concrete has set at least in part, the device 10 is opened, in order to remove the mould from the shaft bottom part 12.

When lifting the shaft bottom part 12 from the inner negative mould 16, the negative channel mould 24 mostly remains strongly adhered to the concrete of the shaft bottom part 12. The relatively heavy mould core 22 which mostly is rigidly connected to the device 10 can then indeed be readily released from the shaft bottom part; however the magnetic coupling between the negative channel mould 24 and the mould core 22 is overcome and the negative channel mould 24 lifts off the mould core 22 together with the shaft bottom part 12. There are several possibilities for separating the negative channel mould 24 from the shaft bottom part 12, too. In principle, before the mould is removed, a mechanical connection can be produced between the mould core 22 and the negative channel mould 24, for example by a screw being screwed into the threaded hole 48 in the coupling body 32 from the mould core 22. A screw of this type then forms second counter coupling means within the meaning of the claims, which means are provided on the same holding device (on the mould core 22) as the first counter coupling means (contact face 52) for magnetic coupling.

However, practical difficulties may be associated with screwing a screw into the threaded hole 48 from the mould core 22. A preferred alternative to separating the negative channel mould 24 from the shaft bottom part 12 is therefore considered to be that of separating the shaft bottom part 12 together with the negative channel mould 24 adhered thereto from the mould core 22 and then, in the manner described below, pulling the negative channel mould 24 from the shaft bottom part by means of a pulling device. In order to take hold of the negative channel mould 24, mechanical coupling means are provided according to the invention which are formed on the coupling body 32. In the embodiment, a hook element 54 comprising a threaded portion 56 is screwed into the internal thread of the threaded hole 48, such that a mechanical threaded connection is produced between the hook element 54 and the coupling body 32. A pulling device (not shown) can then be applied to the hook body 54, for example by an additional hook or an eye of the pulling device hooking into the hook element 54. If a plurality of coupling bodies 32 are provided, as in the embodiment shown, the pulling device can thus produce a mechanical coupling of the above-described type with each of the coupling bodies 32.

The pulling device can then release the negative channel mould 24 from the shaft bottom part 12 by pulling on the coupling body 32. Alternatively, the pulling device can hold the negative channel mould 24 in a stationary manner and can pull the shaft bottom part 12 from the negative channel mould 24.

Once the shaft bottom part 12 is removed from the mould, the hook element 54 can be released (unscrewed) again from the coupling body 32, such that the negative channel mould 24 together with the coupling body 32 inserted therein is prepared for re-use for moulding another shaft bottom part. Alternatively, the coupling body 32 can, more particularly using a suitable tool, be unscrewed again from the negative channel mould 24 and fixed to another negative channel mould 24.

In summary, the coupling body 32 in the embodiment described can also be easily and reliably fixed to less solid materials, such as Styropor, since the fixing means 34 comprise a helically wound rod. A particularly rapid and simple connection to the mould core 22 can be produced by the magnetic coupling means 42, by the negative channel mould 24 being simply placed onto the mould core 22. At the same time, the mechanical coupling means in the form of a threaded hole 48 and of a hook element 54 screwed therein allow a high level of force transmission between a pulling device and the negative channel mould 24, in order for the mould to be reliably removed from the shaft bottom part 12.

1-12. (canceled)

13. A coupling body (32) for coupling a negative channel mould (24), which produces a channel portion of a shaft bottom part (12) to be manufactured from concrete, with a holding device (22), the coupling body (32) comprising:
a fixing portion (34) for fixing the coupling body (32) to the negative channel mould (24) and first coupling means (42) for magnetically coupling with a first counter coupling means (52) of the holding device (22),
wherein the coupling body (32) further comprises second coupling means (48) for mechanically coupling with second counter coupling means (54) of the holding device or of another device.

14. The coupling body (32) of claim 13, wherein the second coupling means (48) are designed for the attachment of a hook coupling element (54).

15. The coupling body (32) of claim 13, wherein the second coupling means (48) comprise an indentation, more particularly a thread arranged in an indentation.

16. The coupling body (32) of claim 13, wherein the first coupling means (42) comprise a permanent magnet.

17. The coupling body (32) of claim 13, wherein the fixing portion (34) comprises a thread which is arranged in a rotationally fixed manner on the coupling body (32), the thread axis of which thread extends coaxially with a main axis (H) of the coupling body (32).

18. The coupling body (32) of claim 13, wherein the fixing portion (34) comprises a rod which is wound into a helix and is fixedly arranged on the coupling body (32).

19. The coupling body (32) of claim 13, wherein the coupling body (32) comprises a tool engagement portion (50), which is designed to engage in a twist-proof manner with a rotary tool in order to rotate the coupling body about the main axis (H).

20. The coupling body (32) of claim 19, wherein the tool engagement portion (50) comprises at least one recess, preferably a plurality of recesses distributed around the main axis (H).

21. A device (10) for producing shaft bottom parts (12) from concrete, comprising:
a negative channel mould (24), which produces a channel portion of a shaft bottom part (12),
a coupling body (32) according to claim 13,
a holding device (22), with which the negative channel mould (24) is to be coupled in order to hold the negative channel mould (24) while the shaft bottom part (12) is moulded, the holding device (22) comprising the first counter coupling portion (52), and
a pulling device for pulling the negative channel mould (24) out of a moulded shaft bottom part (12) which is set at least in part, the pulling device comprising the second counter coupling means (54) for mechanically coupling with the second coupling means (48) of the coupling body (32).

22. The device (10) of claim 21, wherein the negative channel mould (24) is made of a foamed plastics material, more particularly Styropor.

23. The device (10) of claim 21, further comprising a hook coupling element (54), which can be attached to the second coupling means (48).

24. The device (10) of claim 23, wherein the hook coupling element (54) comprises a thread (56), which can be screwed to a thread arranged in an indentation in the coupling body (32).
